(19) United States
(12) Patent Application Publication
(10) Pub. No.: US 2006/0264293 A1
(43) Pub. Date: Nov. 23, 2006

(54) Device for conveying oscillating axial motions to a rotatable roller

(75) Inventors: Ulf Rilbe, Vasteras (SE); Jan Palmcrantz, Harmanger (SE)

Correspondence Address: YOUNG & THOMPSON, 745 SOUTH 23RD STREET, 2ND FLOOR, ARLINGTON, VA, 22202, US

(73) Assignee: SCANDRIVE CONTROL AB, Kolback (SE)

(21) Appl. No.: 10/545,603

(22) PCT Filed: Feb. 13, 2004
(86) PCT No.: PCT/SE04/00186

§ 371 Date: May 10, 2006

(30) Foreign Application Priority Data
Feb. 17, 2003 (SE) 0300411-6

(51) Int. Cl. F16H 1/32

(52) U.S. Cl. 475/168

(57) ABSTRACT

A device for conveying oscillating axial motions to a roller being rotatable around a geometrical main axis of rotation, includes a reduction gear that is connectable to the roller and connected to a transmission member being moveable axially to-and-fro and to a rotor being rotatably journalled in a holder, around a secondary axis of rotation (S) via a hinge radially spaced from the main axis of rotation, the hinge being planetary moveable in a path, whose angle relative to the main axis of rotation determines the axial length of stroke of the transmission member and of the roller. The reduction gear and transmission member are housed in a housing that has a fixed wall shell and a casing serving as holder for the rotor, the casing being turnable relative to the wall shell to provide readjustment of the axial length of stroke of the roller.

### TECHNICAL FIELD OF THE INVENTION

This invention relates to a device for conveying oscillating axial motions to a roller which is rotatable around a geometrical main axis of rotation and which is journalled in a frame, comprising a reduction gear, which is connectable to the roller and connected to a transmission member being rotatable around the main axis of rotation and simultaneously moveable axially to-and-fro in order to gear down the rotation of the roller to a slower rotation of the transmission member, said transmission member being connected to a rotor being rotatably journalled in a holder around a secondary geometrical axis of rotation, via a hinge being radially spaced from the main axis of rotation, said hinge being planetary movable in a path, the angle of which relative to the main axis of rotation determines the axial length of stroke of the transmission member and thereby the axial length of stroke of the roller.

### PRIOR ART

In offset printing presses, dampening apparatus and inking devices, respectively, are included, which have the object of feeding different liquids to a printing plate, which is wound on a cylinder or roller. In order to attain a good printing result, it is required that the application of damp and ink, respectively, to the printing plate is controllable and possible to keep even per unit area so that capturing of ink by the printing plate is solely determined by the screen density of the plate and not by irrelevant parameters. For this purpose, relatively intricate systems of rollers from a primary source of liquid, e.g. a damp box or an ink box, to the printing plate roller are utilized. This printing plate roller has to have a relatively large circumference in order to correspond to the format of the paper to be printed. The other rollers may advantageously be of a considerably smaller diameter. Grade defects tend to occur, inter alia, by the fact that even dyeing of the inking cylinder that finally is to transfer the ink to the printing plate is constantly disrupted by virtue of the ink being consumed, i.e. transferred to the printing plate, in an uneven way along the envelope surface thereof, viz. where one or more printing areas (e.g. a blue sky in an advertisement) are located. For this reason local shortage of ink at the inking cylinder intermittently occurs, and this shortage has to be remedied (i.e. refilled) before the same surface of the inking cylinder is brought into contact with the printing plate the next time.

A radical way of trying to solve this problem is to scrape off all non-transferred ink on the inking cylinder at each turn of revolution, whereupon an entirely new layer of ink is applied from scratch. An inking device that operates in this manner is denominated ANILOX inking device. However, such inking devices have a number of disadvantages that have prevented the break through of the technique.

The predominant inking devices on the market operate with various procedures of eliminating the disadvantages of insufficient rate of replenishing of ink according to above. One way is to use a plurality (e.g. 2 to 4) of inking cylinders having different diameters. Then, each error is divided into a plurality of smaller partial errors that are displaced relative to each other, at least in the circumferential direction. In order to equalize the lateral errors, oscillating rollers are utilized in inking devices as well as in damping apparatus. Such rollers spread or even out the ink and water film, respectively, in the longitudinal direction of the roller while the roller rotates.

In the technical area in question, two different principal types of devices to attain axial oscillation are found, viz., on one hand, devices that are internally mounted in the rollers, and, on the other hand, devices that are externally mounted on the frame carrying the rollers.

Examples of oscillation devices of the internal type are disclosed in WO 93/06999 (see also U.S. Pat. No. 5,704,865), SE 9302892-6 (publication number 501 751) and U.S. Pat. No. 5,429,050.

In practice, however, the most frequently occurring oscillation devices are of the external type, i.e. the devices are mounted on the outside of one of two frame plates between which the oscillatable roller extends, the individual device being connected to a trunnion protruding from an end of the roller. Examples of external oscillation devices are disclosed in U.S. Pat. No. 4,753,167, U.S. Pat. No. 5,309,833 and SE 187 854. However, a disadvantage of these previously known devices is that they are fairly voluminous, which causes component collisions when a drive chain from the ink capturing fountain roller of the inking device to the printing plate roller is to be constructed. Space demanding oscillation devices are of particular inconvenience as a consequence of the design engineer frequently needing to be able to design a number of alternative versions of a principal design. Another disadvantage of previously known, external oscillation devices is that readjustment of the length of stroke of the oscillatory motions only can be effected in a manual way, which in practice implies that the printing presses has to be shut down for a relatively long time. Furthermore, the previously known oscillation devices are constructed with expensive lubrication systems and placed in spaces subjected to open splash lubrication, something that among other things entails a certain risk of oil contamination of other parts of the press. Yet another disadvantage of the known oscillation devices is that they are of an intricate design and consist of many separate components. In practice, this entails that the devices will be expensive to manufacture and maintain.

### OBJECTS AND FEATURES OF THE INVENTION

The present invention aims at obviating the above-mentioned disadvantages of previously known oscillation devices and at providing an improved oscillation device of the external type. A primary object of the invention, therefore, is to provide an oscillation device that is mountable externally on a roller frame and has a minimal volume, so as to make it possible to build-in the same into many different types of printing presses without causing component collisions that will restrain the design engineers freedom while designing load transmissions for different types of printing presses. In particular it is endeavoured that the vital outer dimensions of the oscillation device should not exceed the own outer diameter of the oscillating roller. Furthermore, the device should be possible to manufacture as a freestanding unit or as a standard component that allows to be freely installed in arbitrary printing presses without the component manufacturer need to know about the structure of the individual printing press in advance. Another object of the invention is to provide an oscillation device that in its entirety is enclosed in a sealed housing from which there is no risk of lubricant splashing or leaking out in the surroundings. Furthermore, the device should be possible to manufacture in an uncomplicated and inexpensive manner. In addition, in a particular aspect, the invention aims at providing an oscillation device, the length of stroke of which can be controlled remotely, suitably in such a way that the readjustment thereof can be effected during operation, all with the object of minimising or entirely eliminating the need of shutting down the press when an alteration of the oscillation amplitude of the roller is desired. Furthermore, the readjustment should be possible to accomplish in a rapidly and accurately manner by means of elementary mechanical means.

According to the invention at least the primary object is attained by means of the features that are stated in the characterising part of claim 1. Advantageous embodiments of the invention are further defined in the dependent claims.

Further Demonstration of Prior Art

An oscillation device of the type defined in the preamble of the following claim 1 is previously known through above-mentioned SE 187 854. However, in this case, the parts being included in the device are not at all housed in any splash-proof housing and even less in any housing with a turnable casing to attend readjustment of the length of stroke of the roller. At the known device the reduction gear consists of a space-requiring planetary gear with a plurality of planet wheels, one of which serve as a transmission member. Another disadvantage is that the holder for the rotor (in the shape of a cylindrical sleeve) carrying the planetary movable hinge, constitute of a tilted stud, which is held fixed in a desired angle position by means of a lock nut. In other words the readjustment of the length of stroke of the roller can solely be effected in a manual way after detaching the lock nut.

### BRIEF DESCRIPTION OF THE APPENDED DRAWINGS

In the drawings:

FIG. 1 is a schematic side view illustrating a drive chain between a fountain roller and a printing plate roller in an inking device of an offset printing press,

FIG. 2 is a longitudinal section through an oscillation device according to the invention, said device being connected to an individual roller and shown set in a starting position in which the oscillation amplitude of the roller is equal to zero,

FIG. 3 is an analogous longitudinal section showing a casing included in the device and readjusted so that the roller obtain maximum oscillation amplitude or length of stroke,

FIG. 4 is a corresponding longitudinal section showing the roller rotated half a revolution relative to the position of rotation according to FIG. 3,

FIG. 5 is an enlarged, partial longitudinal section showing only the left part of the device, more precisely in the same state as in FIG. 4,

FIG. 6 is a longitudinal section through an alternative embodiment of the device, and

FIG. 7 is an enlarged detail section A in FIG. 6.

### DETAILED DESCRIPTION OF A PREFERRED EMBODIMENT OF THE INVENTION

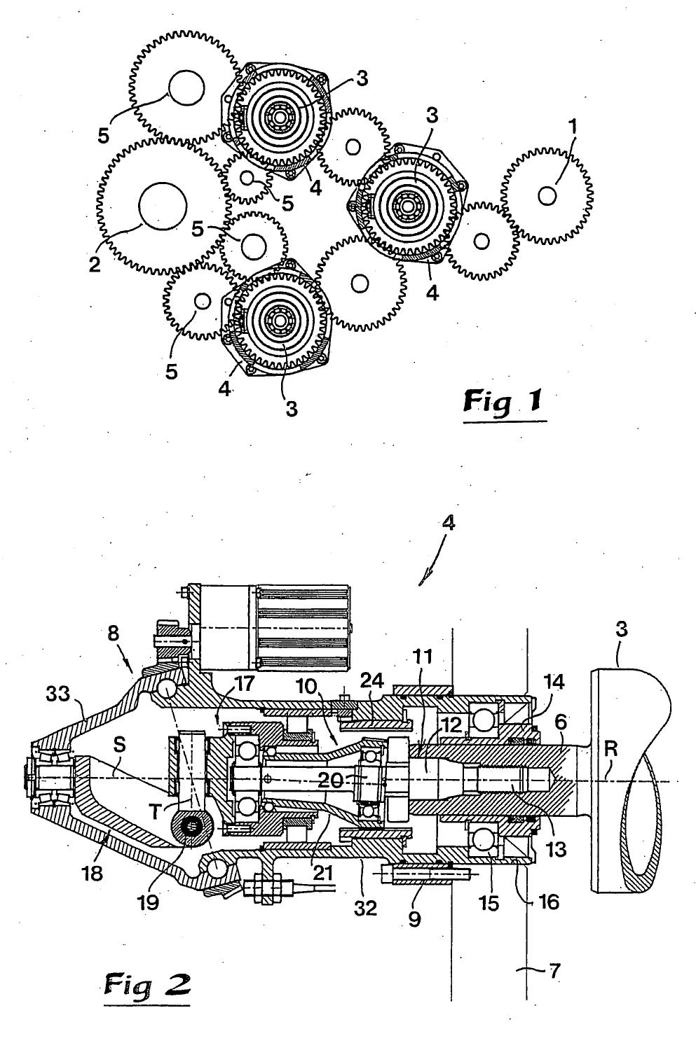

In FIG. 1, a drive chain to an inking device is schematically shown, in which device ink is transferred from a fountain roller 1 to a roller 2 having a screen-equipped printing plate from which ink is transferred to a rubber faced roller, not shown, which in turn effects printing of a paper. In the chain between the fountain roller 1 and the printing plate roller 2, a plurality of rollers 3 are present, three of which are connected to oscillation devices 4 that have the purpose of spreading or evening out the ink layers on the appurtenant rollers by setting these rollers in reciprocating axial motions. Between the two oscillatable rollers shown to the left in FIG. 1 and the printing plate roller 2, four inking cylinders 5 of different diameters are arranged, which distribute the ink in the circumferential direction.

Reference is now made to FIG. 2, which partially illustrates an oscillatable roller 3. At each one of the opposite ends thereof, said roller has a trunnion 6 that is mounted in a frame plate 7. In other words, the roller extends between two such, vertical frame plates 7, which together form a solid frame for an offset printing press.

At the outside of the frame plate 7, an oscillation device 4 according to the invention, is mounted, which device comprises a housing generally designated 8, which is fixedly attached to the frame plate 7 by means of a screw joint 9.

Inside the housing 8, a reduction gear, in its entirety designated 10, is arranged, which in this preferred embodiment is in the form of an eccentric gear. The roller 3 is rotatable around a geometrical main axis of rotation R. At the end thereof shown to the right in FIG. 2, the reduction gear 10 has a coupling part 11 that is concentric to the main axis of rotation R, which coupling part 11 comprises a partially cylindrical and partially conical body 12 and in the extension a stud 13 having a male thread is found, which male thread is screwed into a female thread in a central recess in the trunnion 6. The conical surface of the body 12 is wedged in a seating surface of a corresponding conical shape when the male thread is tightened in the female thread. On the outside of the trunnion 6, a ring 14 is arranged, which via a ball bearing 15 is radially journalled relative to the inner part of the housing 8 that is mounted in a through hole 16 in the frame plate 7. The trunnion 6 is axially movable to-and-fro relative to the ring 14. In other words, the roller 3 may not only rotate relative to the frame plate, but also move axially to-and-fro at a certain length of stroke or oscillation amplitude.

At the left, outer end thereof, the eccentric gear 10 is connected to a transmission member, in its entirety designated 17, which is rotatable as well as axially moveable relative to the housing 8. The transmission member 17 is connected to a rotor element, in its entirety designated 18, which is rotatably journalled relative to the housing 8. More precisely, the transmission member 17 is connected to the rotor element 18 via a hinge 19. The gear 10 has the purpose of gearing down the rotation of the roller 3 to a slower rotation of the transmission member. In practice, the roller may operate at a rotational speed within the range of 800-3000 rpm while the transmission member 17 should not operate at a rotational speed exceeding 200 rpm. In other words, the gear 10 should have a gear ratio within the range of 4:1 to 15:1.

Eccentric gears of the type that is illustrated in the preferred embodiments of the invention are previously well known within the technical area in question. Essential components of the gear is an eccentric body 20 that converts the genuine rotating motion of the trunnion 6 to a nutating motion of a transmission sleeve 21. As more clearly appears from the enlarged section in FIG. 5, said transmission sleeve 21 has an external tooth rim 22 that by only one or just a few teeth is in engagement with an internal tooth rim 23 of a ring 24. The eccentric body 20 is integrated with a shaft 25, the left or outer end of which is rotatably journalled relative to the transmission member 17 via a bearing 26. Torque from the transmission sleeve 21 is transferred to the transmission member 17 via a ball or arch-tooth coupling 27.

The use of an eccentric gear 10 as a reduction gear is not vital to the implementation of the invention, and therefore the function thereof is not described in further detail. The essential thing is that the gear is capable of gearing down the high rotational speed of the roller to a moderate rotational speed of the transmission member. However, in this connection it should be pointed out that an advantage of eccentric gears in particular, compared to other reduction gears, such as planetary gears, is that the same in a single step can ensure large gear changes (10:1 or larger).

Reference is now primarily made to FIG. 5 that illustrates the essential of the invention in an enlarged scale.

Above-mentioned transmission member 17 is made up of two subcomponents, viz. a sleeve 28 that partially enclose the eccentric gear 10 and that, in the example, is rotatably journalled relative to the housing 8 via a roller bearing 29 as well as a front piece 30 that is connected to the sleeve 28 via a screw joint 31. The roller bearing 29 is in turn slidably journalled relative to the housing to be able to move axially to-and-fro therein. In this context it shall be pointed out that the bearing 29 may be accomplished in another way than in the shape of a roller bearing or even be managed without.

According to the invention the housing 8 that accomodates the gear 10 and the transmission member 17 is made up of a fixed wall shell 32 as well as a casing 33 that is turnable relative to the wall shell 32. More precisely the casing is connected to the wall shell via a circular bearing 34, preferably in the shape of an annular ball bearing. The fixed wall shell 32 that is bolted to the frame plate 7, has advantageously cylindrical primary form and a diameter that does not exceed the diameter of the roller 3.

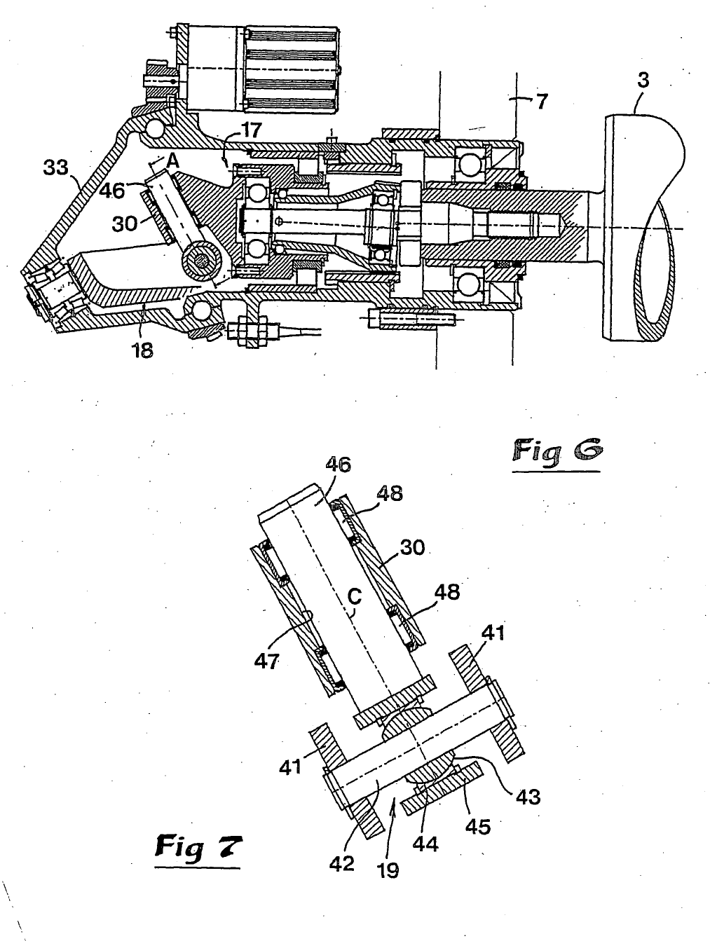

The aforementioned rotor 18 comprises a structural element designated 35 as well as a trunnion 36 that is rotatably journalled in a recess 37 in the casing 33, more precisely via two bearings 38, suitably roller bearings, which allows rotation of the trunnion, but prevents that the same moves axially. Apart from a bottom part 39 and a back piece 40, the structural element 35 comprises two side walls 41 one of which is visible in FIG. 5. In FIG. 7 both side walls 41 are shown in an enlarged detail section, that certainly is inserted as a section A in the alternative embodiment according to FIG. 6, but illustrate the same type of rotor and hinge as in FIGS. 2-5. The hinge, in its entirety designated 19, is made up of a bar 42, e.g. a cylindrical rod, that extends between the side walls 41 as well as a ball or ball body 43 applied to the bar, which ball present a partially spherical shaped surface. The ball 43 is slidably journalled in a ring 44 having a seat which is spherically shaped in an analogous way. The ring 44 is fixed inside an outer sleeve 45 that is associated with a cylindrical pin 46. This pin is in turn rotatably journalled in a through bore 47 in the front piece 30 of the transmission member 17, more precisely by means of at least two axially separated bearings 48 in the form of roller bearings. These bearings 48 allows not only rotation of the cylinder pin 46, but also axial motions to-and-fro in the bore 47. It should be obvious that the cylinder pin 47 serves as a carrier for the sleeve 45 and the ball 43.

In the preferred embodiment (see primarily FIG. 5) the casing 33 has the shape of an asymmetrical cone relative to the annular bearing 34, in the tapered end of which cone the recess 37 for the trunnion 36 is arranged. The rotor 18 is rotatable around a secondary geometrical axis of rotation S, which is defined by the trunnion 36 and the position of which relative to the main axis of rotation R. The circular plane P, in which the bearing 34 is located, is shown with a dashed and dotted line and is tilted in an obtuse angle α to the main axis of rotation R. In the example, the angle amounts to approximately 115°, though also other, larger as well as smaller angles are considerable. However, the angle α should amount to, on one hand, at least 110′ and, on the other hand, at most 120°. Furthermore, the secondary axis of rotation S for the rotor element 18 is tilted in an angle β to the circular plane P of the bearing 34. In the preferred embodiment according to the invention the angle β provide a supplementary angle to the angle α. In other words the angle β amount to 75° provided that the angle α amount to 115°.

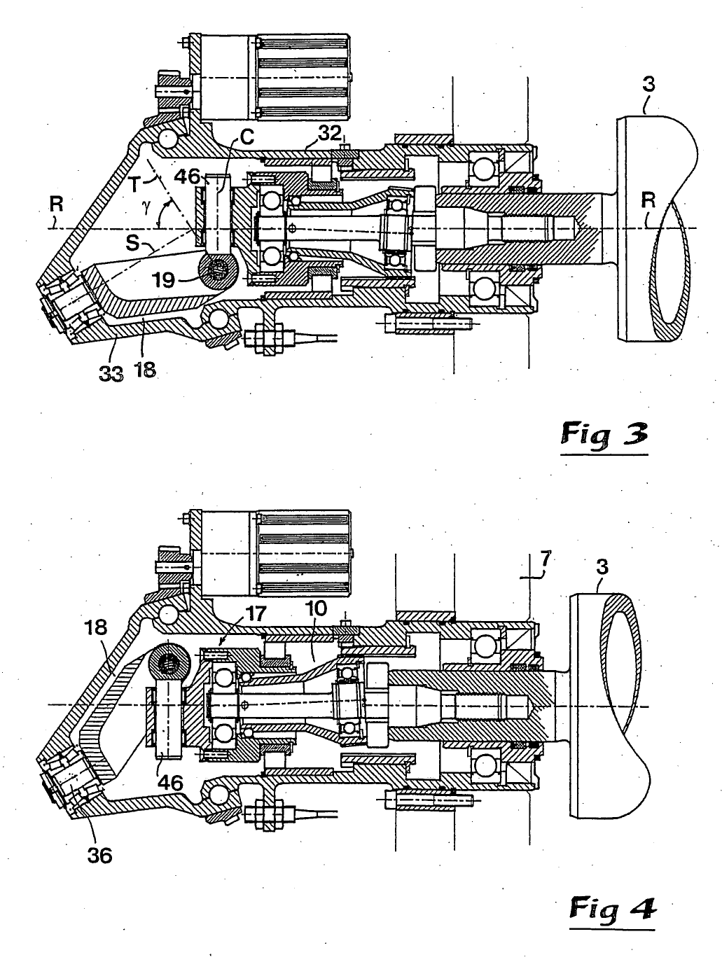

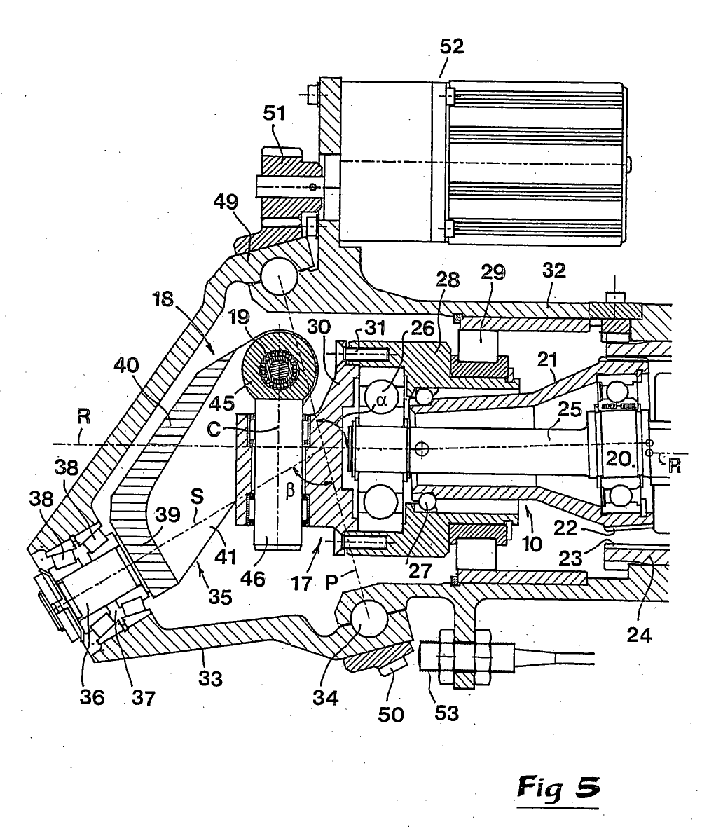

When the rotor 18 rotates the hinge 19 will move in a circular planetary path which is indicated by means of the dashed and dotted line T in FIG. 3. This planetary path T extends in a right angle to the secondary axis of rotation S and is tilted relative to the main axis of rotation R in an acute angle γ in the adjustment position shown in FIGS. 3 and 4, which angle, in the example, amounts to approximately 60°. In other words the angle (complementary angle) between the axes R and S amounts to 30°. In the embodiment shown in FIGS. 2-5 the cylinder pin 46 together with the appurtenant bore 47 in the front piece 30 extends in a right angle (90°) to the main axis of rotation R. This implies that the cylinder pin 46 form a 30° angle to the planet path T. Furthermore, it shall be pointed out that the structural element 35 of the rotor 18 in general is tilted in an acute angle (not shown) to the trunnion 36. In the example, the acute angle amounts to approximately 15°, but may vary upwards as well as downwards.

As is seen in FIG. 5, the secondary axis of rotation S intersect the main axis of rotation R in a point where the plane P of the annular bearing 34 intersect the main axis of rotation. More precisely, said point of intersection form at the same time the midpoint of the circle defined by the bearing 34.

At the outside of a cylindrical end section 49 of the casing 33 (see FIG. 5) a ring is applied, which has a conical shaped gear rim 50. A rotatable gearwheel 51 is engaged with the gear rim 50, and operatable by means of a power source 52, preferably in the form of an electric motor, e.g. a simple diminutive alternating current motor. The control of the operation of the motor is done by means of an inductive non-contact sensor 53 that in a suitable way (e.g. by means of notches or recesses in the gear rim or in the gear rim ring) may read the actual angle of rotation position of the casing relative to the wall shell 32. Thus, by means of the motor the casing 33 may, with great accuracy, be trimmed in desired position relative to the fixed wall shell 32.

The Function of the Device According to the Invention

Presuppose that the roller 3 (see FIGS. 3 and 4) rotates at 2400 rpm and that the eccentric gear 10 has a gear ratio of 12:1. In such a case, the transmission member 17 will rotate at 200 rpm, i.e. in this context a moderate rotational speed. During the rotation of the transmission member 17, the hinge 19 between the transmission member and the rotor 18 will compulsorily convey axial motions to-and-fro to the transmission member, more precisely as a consequence of the casing 33, serving as a holder for the rotor, being fixed or immobile in the appointed setting position thereof. Accordingly, during the first half of a revolution, the hinge 19 in the setting position of the casing 33 according to FIGS. 3 and 4 will move from the position shown at the bottom of FIG. 3 to the position shown at the top of FIG. 4. Thanks to the secondary axis of rotation S for the rotor 18 forms an acute angle that amounts to 30° to the main axis of rotation R in the actual setting position, the hinge 19 will also move in the axial direction during the revolving motion of the rotor and thereby compulsorily convey the transmission member 17 in the same direction. During the first half of a revolution, the hinge and thereby the transmission member will move from an inner end position according to FIG. 3 to an outer end position according to FIG. 4, the roller 3 being conveyed between the inner and the outer end positions as will be seen clearly on a comparison between FIG. 3 and FIG. 4. During the next half of revolution, the hinge, the transmission member and the roller will move from the outer end position according to FIG. 4 back to the inner end position according to FIG. 3. In doing so, the length of stroke of the transmission member and thereby also the axial length of stroke of the roller are determined by the angle between the main axis of rotation R and the planet path T for the hinge 19, more precisely in such a way that an increasing angle lead to a decreasing length of stroke and vice versa.

Reference is now made to FIG. 2, that show the casing 33 set in an angle of rotation position in which the secondary axis of rotation S for the rotor 18 coincide with the main axis of rotation R. In this case the planet path T for the hinge 19 is oriented in a right angle to the main axis of rotation R, whereby neither the transmission member 17 nor the rotating roller moves axially. In other words the length of stroke, in this condition, is equal to zero.

Thanks to the fact that the casing 33 may be turned to an arbitrary angle of rotation position between the primary position according to FIG. 2 and the maximum turned position according to FIGS. 3 and 4, the tilting angle of the planet path T may be trimmed from small to big oscillation amplitudes. Similar readjustments of the oscillation amplitudes may be realized in a simple way even during operation thanks to the simple action of activating the motor 52 through remote control so that the same via the planet wheel 51 (and a housed gear) will convey the casing to turn a desired number of degrees relative to the wall shell 32. Another advantage with the device according to the invention is that the same allows to be designed having a minimal volume to be able to be mounted externally on a roller frame in a simple way without causing troublesome component collisions. In this respect the diminutive motor 52 does not cause problems thanks to the fact that the same at fixation of the wall shell 32 may be located in any angle of rotation position in the periphery area of the housing. Furthermore, the design details which are necessary for the oscillation movements, are housed in a sealed housing from which lubricant does not risk to splash or leak out. Thanks to the fact that the oscillation amplitude of the device may be remotely controlled in an instant and uncomplicated way, the need of shutting down the offset printing press during required readjustment operations disappear.

Reference is now made to FIG. 6, that illustrates an alternative embodiment which only differs in design from the embodiment shown in FIGS. 2-5 in that the cylinder pin 46 for the hinge 19 is oriented in another angle than 90° to the main axis of rotation R. More precisely, the cylinder pin together with the associated bore in the front piece 30 being oriented in a right angle to the secondary axis of rotation S. When the hinge 19 rotate in its planetary path the cylinder pin will therefore move axially to-and-fro in the bore without being subject to any lateral forces.

Feasible Modifications of the Invention

The invention is not limited only to the embodiments described above and shown in the drawings. Thus, it is theoretically possible to use other types of reduction gears than exactly eccentric gears. Furthermore, the rotor as well as the transmission member and the hinge between these components may be designed in different ways within the scope of the following claims.

1. Device for conveying oscillating axial motions to a roller (3) which is rotatable around a geometrical main axis of rotation (R) and which is mounted in a frame (7), comprising a reduction gear (10), which is connectable to the roller (3) and connected to a transmission member (17) being rotatable around the main axis of rotation and simultaneously moveable axially to-and-fro in order to gear down the rotation of the roller to a slower rotation of the transmission member, transmission member being connected to a rotor (18) being rotatably journalled in a holder (33), around a secondary axis of rotation (S) via a hinge (19) being radially spaced from the main axis of rotation (R), hinge being planetary moveable in a path (T), the angle (y) of which relative to the main axis of rotation (R) determines the axial length of stroke of the transmission member and thereby the axial length of stroke of the roller, characterized in that the reduction gear (10) and the transmission member (17) are housed in a housing (8) that comprises a fixed wall shell (32) as well as a casing (33) serving as a holder for the rotor, said casing being turnable relative to the wall shell to pro-vide readjustment of the angle of the guide path (T) relative to the main axis of rotation (R) and thereby the axial length of stroke of the roller (3).

2. Device according to claim 1, characterized in that the casing (33) is turnable relative to the wall shell (32) via a circular bearing (34) the circular plane (P) of which is tilted to a first angle (a°) relative to the main axis of rotation (R), and that the secondary axis of rotation (S) for the rotor (18) is tilted relative to the circular plane of the bearing (34) to a second angle (fig), that forms a supplementary angle to the first angle, whereby the secondary axis of rotation (S) is adjustable in a starting position coaxially to the main axis of rotation (R) and in which posi-tion the planet path (T) of the hinge (19) is oriented in a right angle to the main axis of rotation (R) and the length of stroke of the roller is equal to zero.

3. Device according to claim 1, characterized in that the rotor (18) comprises a trunnion (36) which is rotatably journalled in a recess (37) in the casing (33) and which defines said secondary axis of rotation (S) as well as a structural element (35) which is oriented in an acute angle relative to the trunnion and which comprises two separated side walls (41) between which a bar (42) extends that defines the position of said hinge (19).

4. Device according to claim 3, characterized in that the hinge (19) comprises a ball (43) in addition to said bar (42), said ball being turnably journalled in a seat in a holder (44,45, 46) that is connected to the transmission member (17).

5. Device according to claim 4, characterized in that the holder comprises a cylindrical pin (46) which is turnably journalled in a bore (47) in the transmission member (17) and axially movable to-and-fro therein.

6. Device according to claim 5, characterized in that the cylinder pin (46) extends at a right angle to the main axis of rotation (R).

7. Device according to claim 5, characterized in that the cylinder pin (46) extends at a right angle to the secondary axis of rotation (S).

8. Device according to claim 3, characterized in that the casing has the shape of a cone (33) which is asymmetric relative to the circular bearing (34), and in the tapered end of which the recess (37) for the trunnion (36) is arranged.

9. Device according to claim 2, characterized in that the secondary axis of rotation (S) intersect the main axis of rotation (R) in a point where the midpoint of the circular bearing (34) is located.

10. Device according to claim 1, characterized in that a circular gear rim (50) is connected to the casing (33), a rotatable gear wheel (51) interacts with the gear rim, said gear wheel being operatable by means of a motor (52) and the function of which is to pro-vide turning of the casing between arbitrary angle of rotation positions relative to the wall shell (32).

11. Device according to claim 10, characterized in that an inductive sensor (53) interacts with the gear rim (50) to control the operation of the motor (52).

12. Device according to claim 2, characterized in that the rotor (18) comprises a trunnion (36) which is rotatably journalled in a recess (37) in the casing (33) and which defines said secondary axis of rotation (S) as well as a structural element (35) which is oriented in an acute angle relative to the trunnion and which comprises two separated side walls (41) between which a bar (42) extends that defines the position of said hinge (19).
